(19) United States
(12) Patent Application Publication
(10) Pub. No.: US 2026/0277860 A1
(43) Pub. Date: Sep. 17, 2026

(54) REDUCING THE SIZE OF AN AIRCRAFT OBSTACLE DATABASE

(71) Applicant: THALES, Meudon (FR)

(72) Inventors: Ronan Demoment, Toulouse (FR); Mathieu Wachter, Toulouse (FR); Thomas Bosquet, Toulouse (FR); Lise Bigou, Toulouse (FR); Nahor Moussa, Toulouse (FR)

(21) Appl. No.: 19/563,516

(22) Filed: Mar. 11, 2026

(30) Foreign Application Priority Data
Mar. 13, 2025 (FR) 25 02505

(51) Int. Cl. G06F 16/21; G06F 16/29

(52) U.S. Cl. CPC G06F 16/21; G06F 16/29

(57) ABSTRACT

A method for reducing the size of an obstacle database for an aircraft is provided. In one aspect, the method includes the acquisition of an initial obstacle database including an initial number Nᵢₙᵢₜ of obstacles associated with a predetermined area, for the predetermined area, obtaining a maximum value Nₘₐₓ of obstacles associated with a data processing capacity. Until the current number N of obstacles is equal to Nₘₐₓ, with Nₘₐₓ≤N≤Nᵢₙᵢₜ, the method includes reiteration of the following steps: for each obstacle of the N current obstacles, determining a danger score of the considered obstacle, and among the N obstacles, deleting the obstacle having the lowest danger score, the value of N being, simultaneously or successively to the deletion, decremented by one.

### BACKGROUND

### Field

The present disclosure relates to a method for reducing the size of an obstacle database for an aircraft.

### Description of the Related Technology

Systems for terrain warning and prevention for airplanes are known, also called TAWS (Terrain Awareness and Warning System), as well as terrain warning and prevention systems for helicopters, also called HTAWS (Helicopter TAWS).

### SUMMARY OF CERTAIN INVENTIVE ASPECTS

The present disclosure relates to a method for reducing the size of an obstacle database for an aircraft, the obstacle database being configured to be used by an avionics system, each obstacle being modeled by a cylinder, vertical relative to the ground, defined by its radius, its height, and the altitude of its upper surface, the method being implemented by an electronic reduction device.

The disclosure also relates to a computer program including software instructions which, when executed by a computer, implement such a method for reducing the size of an obstacle database for an aircraft.

The disclosure also relates to a computer-readable medium, comprising an obstacle database for an aircraft, the size of the obstacle database having been reduced via such a reduction method.

The disclosure also relates to an electronic device for reducing the size of an obstacle database for an aircraft, the electronic device being configured to implement such a method for reducing the size of an obstacle database for an aircraft.

The disclosure relates to the field of modeling obstacles or points of interest in a geographic database for an aircraft. Such databases are hereinafter called obstacle databases for an aircraft and are used by avionics systems, in particular by systems for preventing and warning of the risks of aircraft collision with obstacles.

Each obstacle database is then, for example, included in the avionics system, such as the prevention and warning system; or alternatively stored on a computer medium connected to the avionics system, such as the prevention and warning system.

In other words, the fields of application are those of onboard aeronautical applications whether in a prevention function (awareness) and/or warning (alerting), synthetic vision systems (SVS), or alternatively PC (Personal Computer)/Web computer applications for cartographic display (DMAP) (digital map, i.e. digitized terrain map).

In particular, systems for terrain warning and prevention for airplanes are known, also called TAWS (Terrain Awareness and Warning System), as well as terrain warning and prevention systems for helicopters, also called HTAWS (Helicopter TAWS).

These avionics systems are mandatory for airliners, as well as transport and regional aircraft, and are becoming so for helicopters. In civil aviation, Terrain and Obstacle Warning Systems (TAWS) use obstacle databases built from diverse and varied sources, often governmental.

These sources can vary enormously in quality, quantity, and in the way obstacles are modeled. All nonetheless share a common characteristic: over time, with the constant improvement in the efficiency of technologies for identifying obstacles, these obstacle databases used in aeronautics continue to grow in volume, the number of obstacles sometimes increasing exponentially, certain areas being able to comprise a number of obstacles exceeding one thousand obstacles per square kilometer.

In addition, the way in which some obstacles are modeled aggravates this phenomenon by using, for example, as illustrated by FIG. 1, several dozen virtual obstacles to represent a single wind turbine or a single tower, each obstacle Obst being modeled by a cylinder, vertical relative to the ground, defined by its radius R, its height H, and the altitude A of its upper surface (i.e. the altitude of the highest point), its position in latitude and longitude moreover also being stored within the database.

If future solutions may perhaps be adapted to this growth, existing solutions, already deployed and certified, must necessarily use reduced-size databases.

For example, TAWS onboard civil aircraft fleets are sometimes 20 years old and cannot process such a volume of data, whereas safety requires regular updating of this data. TAWS in operation are often limited to a few hundred obstacles for a radius of several kilometers around the aircraft. Exceeding this limit leads to degradation, or even malfunction, of the avionics system. Note that filtering based on height or altitude only (keeping the highest obstacles) has no “aeronautical meaning” because it does not take into account their geographic distribution.

There are techniques based on algorithms allowing the number and density of obstacles in an area to be reduced by analyzing and merging them or enclosing them based on operational criteria. These algorithms are capable of identifying modifications that always go in the direction of safety, for example, by replacing a group of close obstacles with a single obstacle enclosing them. They nonetheless have a drawback in that they cannot guarantee in advance the number of obstacles they can remove and thus the maximum number of obstacles in the database.

If a certain number of simple operational criteria could be considered to reduce the number of obstacles, nothing makes it possible to reach a maximum value defined in advance.

Other existing solutions address the problem of filtering obstacles, and do so from the point of view of the aircraft but in flight, at an instant t, to consider at that instant only those that are significant in terms of safety, such that they do not provide a solution for reduction, as such and effective, of the size of the database suitable to be onboard within the aircraft.

In other words, none of the existing solutions addresses the problem of database sizes and the pre-flight limitation of their density and consequently the number of obstacles they contain, so as not to exceed the capacities of the computers of onboard avionics systems.

The aim of the disclosure is then to propose a solution suitable to guarantee that the maximum number of obstacles does not exceed a predefined value, whatever it may be.

To this end, the disclosure relates to a method for reducing the size of an obstacle database for an aircraft, the obstacle database being configured to be used by an avionics system, each obstacle being modeled by a cylinder, vertical relative to the ground, defined by its radius, its height, and the altitude of its upper surface, the method being implemented by an electronic reduction device, and comprising the following steps:
acquisition of an initial obstacle database, the initial obstacle database comprising an initial number Nᵢₙᵢₜ of obstacles associated with a predetermined geographic area;
for said predetermined geographic area, obtaining a predetermined maximum value Nₘₐₓ of obstacles associated with the data processing capacity of said avionics system;
   and until the current number N of obstacles of said obstacle database is equal to said predetermined maximum value Nₘₐₓ of obstacles, with Nₘₐₓ≤N≤Nᵢₙᵢₜ, reiteration of the following steps:
for each obstacle of said N current obstacles, determining a danger score of said considered obstacle, said danger score of said considered obstacle corresponding to the minimum of the danger values obtained for said considered obstacle relative to each other obstacle among said N−1 obstacles distinct from said considered obstacle, each danger value associated with a pair of obstacles comprising said considered obstacle and another obstacle among said N−1 obstacles depending at least on:
the distance between said considered obstacle and said other obstacle of said pair;
the altitudes and the respective radii of the obstacles of said pair,
among said N obstacles, deleting the obstacle having the lowest danger score, the value of N being, simultaneously or successively to said deletion, decremented by one,
   and once the current number N of obstacles of said obstacle database is equal to said predetermined maximum value Nₘₐₓ of obstacles, obtaining the reduced-size obstacle database suitable to be subsequently onboard within said avionics system.

Thus, the method for reducing the size of an obstacle database for an aircraft according to the present disclosure proposes deleting obstacles, step by step (i.e. obstacle by obstacle, a single obstacle being deleted at each iteration), by minimizing the impact of this deletion on flight safety, i.e., by deleting the least dangerous obstacles from an operational point of view.

Indeed, the present disclosure makes it possible to reduce the number of obstacles to a strict value by keeping only the most dangerous obstacles, the least dangerous being deleted.

In other words, the present disclosure proposes limiting the obstacle density to an exact given value corresponding to the limit acceptable by the avionics system (or by the avionics application) intended to exploit the obstacle database, in a determined area.

The present disclosure makes it possible to meet requirements according to which the maximum obstacle limit, defined by the processing capacity of the relevant avionics system, will never be exceeded. Moreover, compared with the aforementioned existing techniques based on algorithms allowing the number and density of obstacles in an area to be reduced by analyzing and merging them or enclosing them based on operational criteria, the present disclosure deletes only the least dangerous obstacles for an aircraft, whatever its origin relative to the obstacle in the database, but no obstacle is modified.

Thus, the present disclosure proposes succeeding in limiting the obstacle density of an obstacle database in order to allow its use by onboard functions of the TAWS type, with limited resources, existing, already deployed and certified, and which cannot absorb the constant growth of official obstacle sources.

According to other advantageous aspects of the disclosure, the method for reducing the size of an obstacle database for an aircraft comprises one or more of the following features, taken alone or in all technically possible combinations:
said distance is orthodromic;
said danger score D_{ref} of said considered O_{ref} obstacle is expressed via the following expression:

$${D}_{ref} = {Min}_{n \neq ref} [ {D}_{ref / n} ]$$

with D_{ref/n} being the danger value associated with a pair of obstacles comprising said considered obstacle O_{ref} and another obstacle Oₙ among said N−1 obstacles distinct from said considered obstacle O_{ref}, such as:

$${D}_{ref / n} = Distance ( {O}_{ref} , {O}_{n} ) - Altitude ( {O}_{n} ) + Altitude ( {O}_{ref} ) - Radius ( {O}_{n} ) + Radius ( {O}_{ref} )$$

where Radius(Oₙ) and Radius(O_{ref}) are the respective radii of the obstacles O_{ref} and Oₙ of said pair.
each danger value associated with a pair of obstacles comprising said considered obstacle and another obstacle among said N−1 obstacles further depends on the height of said other obstacle of said pair;
the danger value associated with a pair of obstacles comprising said considered obstacle O_{ref} and another obstacle Oₙ among said N−1 obstacles distinct from said considered obstacle O_{ref} is then such that:

$${D}_{ref / n} = Distance ( {O}_{ref} , {O}_{n} ) - Altitude ( {O}_{n} ) + Altitude ( {O}_{ref} ) - Radius ( {O}_{n} ) + Radius ( {O}_{ref} ) + f ( {O}_{n} )$$

with ƒ(Oₙ) being a function configured to reduce the danger value when the height H(Oₙ) of the other obstacle Oₙ decreases;
said function ƒ(Oₙ) is defined as follows:

$$f ( {O}_{n} ) = 0 , if H ( {O}_{n} ) > {H}_{1}$$

$$f ( {O}_{n} ) = - ∞ , if H ( {O}_{n} ) \leq {H}_{2}$$

$$f ( {O}_{n} ) = k \cdot {log}_{10} ( H ( {O}_{n} ) - {H}_{2} ) , else ,$$

with H₁ and H₂ being predetermined height thresholds such that H₂<H₁;
the height threshold H₁ is substantially equal to 150 m and the height threshold H₂ is substantially equal to 50 m.

The disclosure also relates to a computer program including software instructions which, when executed by a computer, implement a method for reducing the size of an obstacle database for an aircraft as defined above.

The disclosure also relates to a computer-readable medium, comprising an obstacle database for an aircraft, the size of the obstacle database having been reduced via a reduction method as defined above.

The disclosure also relates to an electronic device for reducing the size of an obstacle database for an aircraft, said electronic device being configured to implement such a method for reducing the size of an obstacle database for an aircraft.

### BRIEF DESCRIPTION OF THE DRAWINGS

The disclosure will appear more clearly from reading the following description, given solely by way of non-limiting example, and made with reference to the drawings wherein:

FIG. 1, already described above, illustrates how currently a single wind turbine or a single tower is suitable to be represented by about ten cylindrical obstacles within an obstacle database;

FIG. 2 is a schematic view of an electronic device for reducing the size of an obstacle database for an aircraft according to one embodiment of the disclosure;

FIG. 3 is a flowchart of a method, according to the disclosure, for reducing the size of an obstacle database for an aircraft, the method being implemented by the electronic device shown in FIG. 2;

FIG. 4 is a schematic representation illustrating the different parameters taken into account to determine the danger score of an obstacle according to one embodiment of the present disclosure;

FIG. 5 illustrates two examples of reductions in the number of obstacles obtained by means of the disclosure.

### DETAILED DESCRIPTION

In the remainder of the description, the expression “substantially equal to” defines a relation of equality within plus or minus 20%, preferably within plus or minus 10%, more preferably within plus or minus 5%.

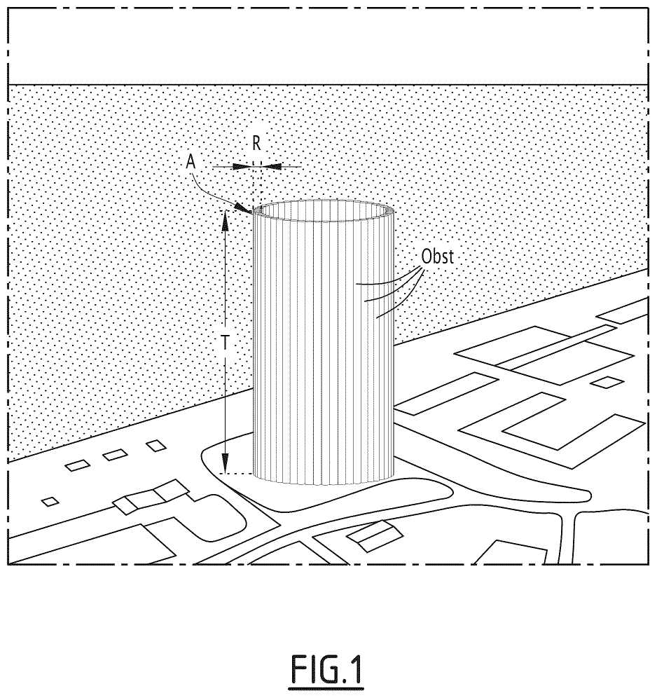

FIG. 1 has already been described above in relation to the prior art and will therefore no longer be described hereinafter.

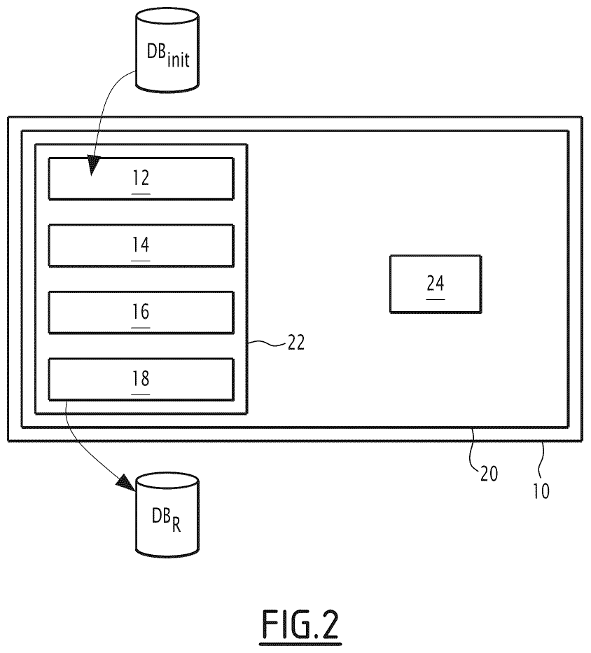

FIG. 2 then schematically illustrates a non-limiting example of an electronic device 10 for reducing the size of an obstacle database for an aircraft according to the present disclosure.

According to this exemplary embodiment, the electronic device 10 for reducing the size of an obstacle database for an aircraft first comprises an acquisition module 12 configured to acquire an initial obstacle database DBᵢₙᵢₜ, the initial obstacle database DBᵢₙᵢₜ comprising an initial number Nᵢₙᵢₜ of obstacles associated with a predetermined geographic area.

The electronic device 10 further comprises a first obtaining module 14 configured to obtain, for said predetermined geographic area, a predetermined maximum value Nₘₐₓ of obstacles (i.e. a maximum obstacle number limit) associated with the data processing capacity of said avionics system.

The electronic device 10 further comprises a module 16 for determining a danger score of an obstacle and deleting an obstacle as a function of the value of its danger score, this module being implemented iteratively until the current number N of obstacles of said obstacle database is equal to said predetermined maximum value Nₘₐₓ of obstacles, with Nₘₐₓ≤N≤Nᵢₙᵢₜ, and at each iteration configured to:
for each obstacle of said N current obstacles, determine a danger score of said considered obstacle, said danger score of said considered obstacle corresponding to the minimum of the danger values obtained for said considered obstacle relative to each other obstacle among said N−1 obstacles distinct from said considered obstacle, each danger value associated with a pair of obstacles comprising said considered obstacle and another obstacle among said N−1 obstacles depending at least on:
the distance between said considered obstacle and said other obstacle of said pair;
the altitudes and the respective radii of the obstacles of said pair,
among said N obstacles, delete the obstacle having the lowest danger score, the value of N being simultaneously decremented by one.

The electronic device 10 further comprises a second obtaining module 18 configured to obtain the reduced-size obstacle database DB_{R} suitable to be subsequently onboard within said avionics system, once the current number N of obstacles of said obstacle database is equal to said predetermined maximum value Nₘₐₓ of obstacles (i.e. has been reduced step by step at each iteration to move from the initial number Nᵢₙᵢₜ of obstacles to the predetermined maximum value Nₘₐₓ of obstacles associated with the data processing capacity of said avionics system).

In the example shown in FIG. 2, the electronic reduction device for reducing the size of an obstacle database for an aircraft comprises an information processing unit 20 formed, for example, by a memory 22 and a processor 24 associated with the memory 22.

In the example shown in FIG. 2, the acquisition module, the first obtaining module, the module for determining a danger score of an obstacle and deleting an obstacle as a function of the value of its danger score, the second obtaining module, are each implemented in the form of software, or a software brick, executable by the processor. The memory of the electronic device for reducing the size of an obstacle database for an aircraft is then suitable to store acquisition software, first obtaining software, and software for determining a danger score of an obstacle and deleting an obstacle as a function of the value of its danger score, and second obtaining software. The processor is then suitable to execute each of the software among the first obtaining software, the first obtaining software, and the software for determining a danger score of an obstacle and deleting an obstacle as a function of the value of its danger score, and the second obtaining software.

In a non-illustrated variant, the acquisition module, the first obtaining module, and the module for determining a danger score of an obstacle and deleting an obstacle as a function of the value of its danger score, and the second obtaining module, are each implemented in the form of a programmable logic component, such as an FPGA (Field Programmable Gate Array), or alternatively an integrated circuit, such as an ASIC (Application Specific Integrated Circuit).

When the electronic device for reducing the size of an obstacle database for an aircraft is implemented in the form of one or more software programs, i.e., in the form of a computer program, also called a computer program product, it is moreover suitable to be recorded on a medium (not shown) readable by computer. The computer-readable medium is, for example, a medium suitable to store electronic instructions and to be coupled to a bus of a computer system. By way of example, the readable medium is an optical disk, a magneto-optical disk, a ROM memory, a RAM memory, any type of non-volatile memory (for example, FLASH or NVRAM), or a magnetic card. A computer program comprising software instructions is then stored on the readable medium.

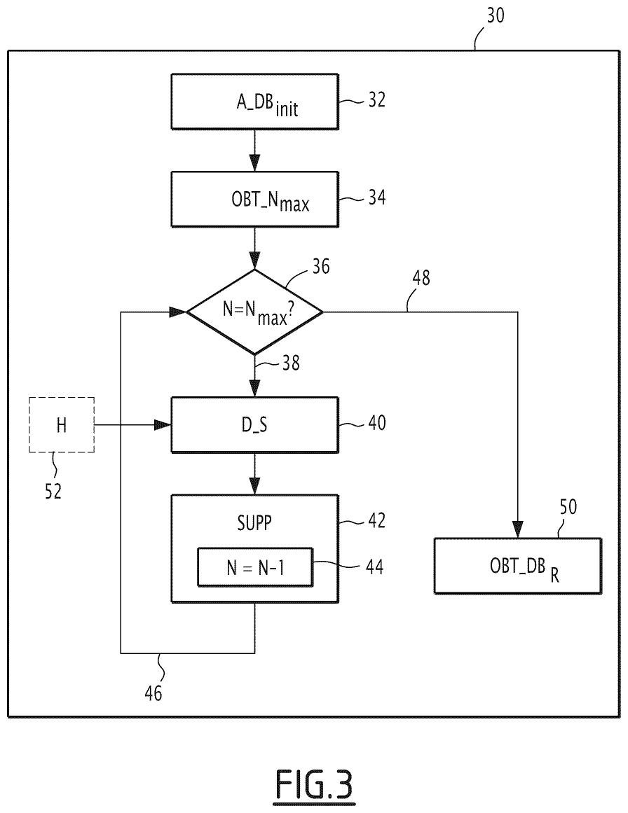

The following describes, in relation to FIG. 3, an example of a general embodiment of the operation of the electronic device 10 shown in FIG. 2.

More precisely, the method 30 for reducing the size of an obstacle database for an aircraft implemented by such an electronic device 10 first comprises a step 32 of acquiring A_DBᵢₙᵢₜ an initial obstacle database DBᵢₙᵢₜ, the initial obstacle database comprising an initial number Nᵢₙᵢₜ of obstacles associated with a predetermined geographic area.

Then, according to a step 34, the method 30 for reducing the size of an obstacle database for an aircraft according to the present disclosure comprises, for said predetermined geographic area, obtaining OBT_Nₘₐₓ a predetermined maximum value Nₘₐₓ of obstacles associated with the data processing capacity of said avionics system.

Then, two steps are implemented successively over a plurality of iterations until the current number N of obstacles of said obstacle database is equal to said predetermined maximum value Nₘₐₓ of obstacles.

Note that, at the beginning of the first iteration, the current number N of obstacles is equal to the initial number Nᵢₙᵢₜ.

At each iteration, according to a step 36, it is first tested whether or not the current number N of obstacles of said obstacle database is equal to said predetermined maximum value Nₘₐₓ of obstacles.

If not, according to arrow 38, steps 40 to 44 are then implemented.

Step 40 consists in implementing, for each obstacle of said N current obstacles, determining D_S a danger score of said considered obstacle, said danger score of said considered obstacle corresponding to the minimum of the danger values obtained for said considered obstacle relative to each other obstacle among said N−1 obstacles distinct from said considered obstacle, each danger value associated with a pair of obstacles comprising said considered obstacle and another obstacle among said N−1 obstacles depending at least on:
the distance between said considered obstacle and said other obstacle of said pair;
the altitudes and the respective radii of the obstacles of said pair.

Indeed, to allow the method according to the present disclosure to delete the least dangerous obstacles, it is necessary to define numerically the level of dangerousness, from an operational point of view, of each obstacle. That is to say, it is necessary to quantify the risk, for an aircraft, of not being aware of this obstacle.

According to the present disclosure, this danger score depends in first order on the height of the obstacle, its radius, the fact that it is neighboring or not to a more substantial obstacle (masking), and this considering an equiprobability in the aircraft-obstacle directions.

Note that, as an optional complement, said distance is orthodromic, which advantageously makes it possible to take into account the sphericity of the planet.

Then, once the danger score of each obstacle of said N current obstacles is obtained, according to step 42, deletion SUPP of the obstacle having the lowest danger score is implemented, and according to step 44, the value of N is, simultaneously or successively to said deletion, decremented by one.

According to reiteration arrow 46, step 36 according to which it is tested whether or not the current number N of obstacles of said obstacle database is equal to said predetermined maximum value Nₘₐₓ of obstacles, is reiterated with the value of N previously decremented by one unit during step 44. If not, according to arrow 38, as described above, steps 40 to 44 are reiterated.

If so, according to arrow 48, i.e., once the current number N of obstacles of said obstacle database is equal to said predetermined maximum value Nₘₐₓ of obstacles, the iterations are finished and, according to step 50, there is an obtaining OBT_DB_{R} of the reduced-size obstacle database suitable to be subsequently onboard within said avionics system.

As an optional complement, each danger value associated with a pair of obstacles comprising said considered obstacle and another obstacle among said N−1 obstacles further depends on the height T of said other obstacle of said pair obtained according to a step 52.

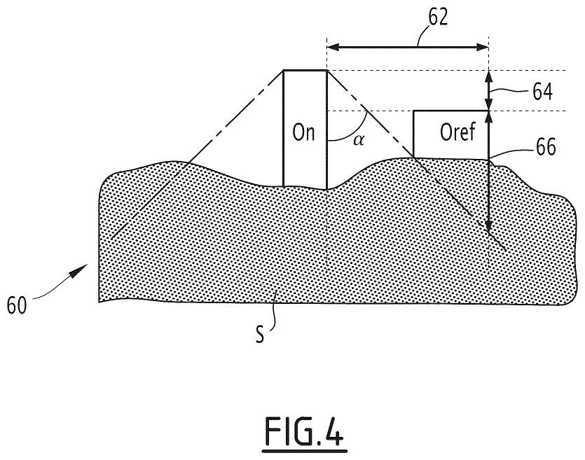

FIG. 4 is a schematic representation 60 illustrating the different parameters taken into account to determine the danger score of an obstacle O_{ref} according to one embodiment of the present disclosure.

Indeed, for a given geographic area containing N current obstacles (N being equal to the initial number Nᵢₙᵢₜ), as an optional complement, said danger score D_{ref} of said considered obstacle O_{ref} is expressed via the following expression:

$${D}_{ref} = {Min}_{n \neq ref} [ {D}_{ref / n} ]$$

with D_{ref/n} being the danger value associated with a pair of obstacles comprising said considered obstacle O_{ref} and another obstacle Oₙ among said N−1 obstacles distinct from said considered obstacle O_{ref}, such as:

$${D}_{ref / n} = Distance ( {O}_{ref} , {O}_{n} ) - Altitude ( {O}_{n} ) + Altitude ( {O}_{ref} ) - Radius ( {O}_{n} ) + Radius ( {O}_{ref} )$$

where Radius(Oₙ) and Radius(O_{ref}) are the respective radii of the obstacles O_{ref} and Oₙ of said pair.

In other words, for a given obstacle O_{ref}, at each iteration, the danger it represents is evaluated by calculating its danger score. This score is calculated by comparing O_{ref} to each of the other N−1 obstacles in the area.

In FIG. 4, the considered obstacle O_{ref} and another distinct obstacle Oₙ are shown, in a vertical cross-section, on the ground S. The distance corresponding to the expression: Distance (O_{ref}, Oₙ)−Radius(Oₙ)+Radius(O_{ref}), is illustrated in FIG. 4 by the horizontal double arrow 62, while the altitude difference Altitude(Oₙ)−Altitude(O_{ref}) is represented in FIG. 4 by the vertical double arrow 64.

D_{ref/n} being the danger value associated with a pair of obstacles is for its part represented in FIG. 4 by the vertical double arrow 66, and represents the distance by which O_{ref} exceeds a cone Oₙ with apex and slope a. For example, a is substantially equal to 45°.

The global score D_{ref} is the minimum danger score of O_{ref} relative to all its neighboring obstacles. If this score D_{ref} is low, this means that O_{ref} is “protected” by one of its neighbors and can be removed without risk. If the score O_{ref} is instead high, this means that O_{ref} is far from its neighbors or alternatively that it is higher in altitude and that it is risky to remove it.

Thus, taking into account, according to the disclosure, the term distance (O_{ref}, Oₙ has the effect of favoring the deletion of obstacles belonging to “clusters” and favoring the preservation of isolated obstacles. This helps simplify clusters of obstacles, for example, when large buildings have been modeled using many obstacles of small radii.

Taking into account, according to the disclosure, the difference Altitude(O_{ref})−Altitude(Oₙ) favors the deletion of the lowest obstacles. When a cluster of obstacles is present, the algorithm will preserve the highest of the group.

Taking into account, according to the disclosure, the difference Radius(O_{ref})−Radius(Oₙ) favors the deletion of the narrowest obstacles when the heights of neighboring obstacles are of the same order of magnitude.

As indicated above in relation to FIG. 2, optionally, each danger value associated with a pair of obstacles comprising said considered obstacle and another obstacle among said N−1 obstacles further depends on the height of said other obstacle of said pair.

Indeed, it may be of interest to make the terrain elevation and therefore the obstacle height intervene in the danger evaluation. Protection against obstacle collision is always accompanied by equivalent terrain protection, so it is unnecessary to keep obstacles whose height is so low that no aircraft can approach it without triggering a terrain alert.

Such an option, namely the additional taking into account of height, advantageously makes it possible to more easily delete obstacles close to the ground, whatever their altitude.

According to this option, the danger value associated with a pair of obstacles comprising said considered obstacle O_{ref} and another obstacle Oₙ among said N−1 obstacles distinct from said considered obstacle O_{ref} is then such that:

$${D}_{ref / n} = Distance ( {0}_{ref} , {0}_{n} ) - Altitude ( {0}_{ref} ) - Radius ( {0}_{n} ) + Radius ( {0}_{ref} ) + f ( {0}_{n} )$$

with ƒ(Oₙ) being a function configured to reduce the danger value when the height H(Oₙ) of the other obstacle Oₙ decreases.

According to a variant of this option, said function ƒ(Oₙ) is defined as follows:

$$f ( {0}_{n} ) = 0 , if H ( {0}_{n} ) > {H}_{1}$$

$$f ( {0}_{n} ) = - ∞ , if H ( {0}_{n} ) \leq {H}_{2}$$

$$f ( {0}_{n} ) = k \cdot {log}_{10} ( H ( {0}_{n} ) - {H}_{2} ) , else ,$$

with H₁ and H₂ being predetermined height thresholds such that H₂<H₁.

As an optional complement to this option, the height threshold H₁ is substantially equal to 150 m and the height threshold H₂ is substantially equal to 50 m, which corresponds to the example according to which obstacles of 30 m or less are considered not dangerous and those of 150 m or more are no longer protected by the terrain.

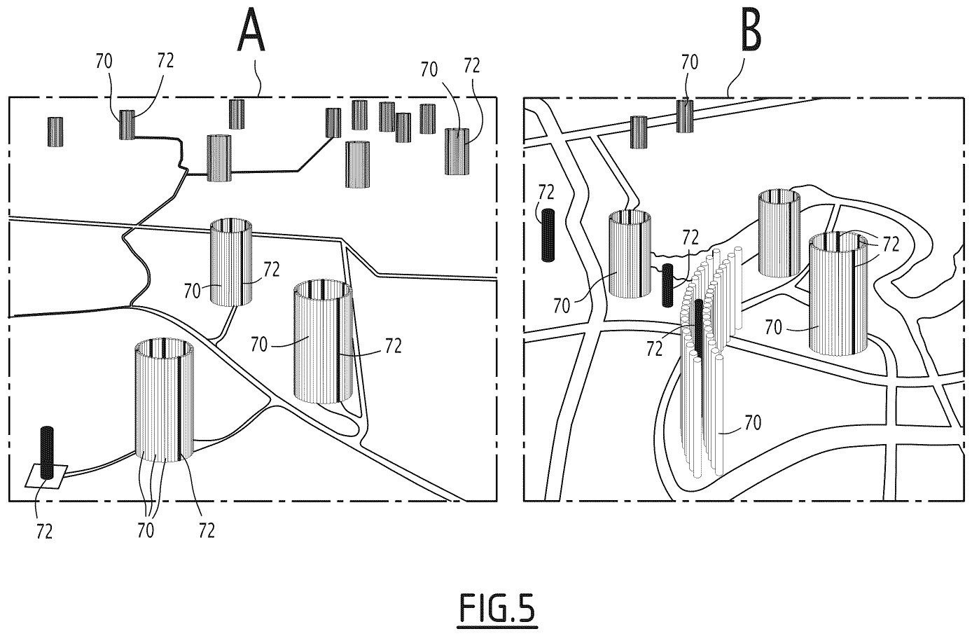

FIG. 5 illustrates two examples of reductions in the number of obstacles obtained by means of the present disclosure. In views A and B of FIG. 5, associated respectively with different geographic areas, the obstacles 70 shown in white are advantageously deleted step by step so as to keep, at the end of the iterative method according to the present disclosure, only the obstacles 72 shown in black.

For example, the method according to the present disclosure makes it possible to reduce the initial number Nᵢₙᵢₜ equal to 2,500 obstacles down to the number Nₘₐₓ equal to 300 obstacles, i.e. a reduction in the number of obstacles by a factor of 8.

The results of views A and B illustrate that the method according to the present disclosure keeps an obstacle 72 representative in height of the surrounding obstacles.

In addition, view A illustrates that the method according to the present disclosure has the effect of simplifying the initial clusters of obstacles, and view B illustrates that the method according to the present disclosure takes into account the spatial distribution of obstacles.

A person skilled in the art will understand that the disclosure is not limited to the described embodiments, nor to the particular examples of the description, the embodiments and variants mentioned above being suitable to be combined with one another to generate new embodiments of the disclosure.

The present disclosure thus makes it possible to provide “intelligent” obstacle deletion based on dangerousness criteria in an aeronautical “aircraft” context, or even more precisely “airplane”, while being agnostic to the aircraft-obstacle heading.

What is claimed is:

1. A method for reducing a size of an obstacle database for an aircraft, the obstacle database being configured to be used by an avionics system, each obstacle being modeled by a cylinder, vertical relative to a ground, defined by its radius, its height, and an altitude of its upper surface, the method being implemented by an electronic reduction device, and the method comprising:
acquisition of an initial obstacle database, the initial obstacle database comprising an initial number Nᵢₙᵢₜ of obstacles associated with a predetermined geographic area;
for said predetermined geographic area, obtaining a predetermined maximum value Nₘₐₓ of obstacles associated with a data processing capacity of said avionics system;
and until a current number N of obstacles of said obstacle database is equal to said predetermined maximum value Nₘₐₓ of obstacles, with Nₘₐₓ≤N≤Nᵢₙᵢₜ, reiteration of the following steps:
for each obstacle of said N current obstacles, determining a danger score of a considered obstacle, said danger score of said considered obstacle corresponding to a minimum of the danger values obtained for said considered obstacle relative to each other obstacle among N−1 obstacles distinct from said considered obstacle, each danger value associated with a pair of obstacles comprising said considered obstacle and another obstacle among said N−1 obstacles depending at least on:
a distance between said considered obstacle and said other obstacle of said pair;
the altitudes and respective radii of the obstacles of said pair,
among said N obstacles, deleting the obstacle having a lowest danger score, the value of N being, simultaneously or successively to said deletion, decremented by one, and
once the current number N of obstacles of said obstacle database is equal to said predetermined maximum value Nₘₐₓ of obstacles, obtaining a reduced-size obstacle database suitable to be subsequently onboard within said avionics system.

2. The method according to claim 1, wherein said distance is orthodromic.

3. The method according to claim 2, wherein said danger score D_{ref} of said considered obstacle O_{ref} is expressed via the following expression:
$${D}_{ref} = {Min}_{n \neq ref} [ {D}_{ref / n} ]$$
with D_{ref/n} being the danger value associated with a pair of obstacles comprising said considered obstacle O_{ref} and another obstacle Oₙ among said N−1 obstacles distinct from said considered obstacle O_{ref}, such as:
$${D}_{ref / n} = Distance ( {O}_{ref} , {O}_{n} ) - Altitude ( {O}_{n} ) + Altitude ( {O}_{ref} ) - Radius ( {O}_{n} ) + Radius ( {O}_{ref} )$$
where Radius(Oₙ) and Radius(O_{ref}) are the respective radii of the obstacles O_{ref} and Oₙ of said pair.

4. The method according to claim 1, wherein each danger value associated with a pair of obstacles comprising said considered obstacle and another obstacle among said N−1 obstacles further depends on the height of said other obstacle of said pair.

5. The method according to claim 4, wherein the danger value associated with a pair of obstacles comprising said considered obstacle O_{ref} and another obstacle Oₙ among said N−1 obstacles distinct from said considered obstacle O_{ref}, is then such that:
$${D}_{ref / n} = Distance ( {O}_{ref} , {O}_{n} ) - Altitude ( {O}_{n} ) + Altitude ( {O}_{ref} ) - Radius ( {O}_{n} ) + Radius ( {O}_{ref} ) + f ( {O}_{n} )$$
with ƒ(Oₙ) being a function configured to reduce the danger value when the height H(Oₙ) of the other obstacle Oₙ decreases.

6. The method according to claim 5, wherein said function ƒ(Oₙ) is defined as follows:
$$f ( {O}_{n} ) = 0 , if H ( {O}_{n} ) > {H}_{1}$$
$$f ( {O}_{n} ) = - ∞ , if H ( {O}_{n} ) \leq {H}_{2}$$
$$f ( {O}_{n} ) = k \cdot {log}_{10} ( H ( {O}_{n} ) - {H}_{2} ) , else ,$$
with H₁ and H₂ being predetermined height thresholds such that H₂<H₁.

7. The method according to claim 6, wherein a height threshold H₁ is substantially equal to 150 m and the height threshold H₂ is substantially equal to 50 m.

8. A computer program including software instructions which, when executed by a computer, implement a method according to claim 1.

9. A non-transitory computer-readable medium, comprising an obstacle database for an aircraft, wherein the size of the obstacle database has been reduced by means of a method according to claim 1.

10. An electronic device for reducing the size of an obstacle database for an aircraft, the electronic device being configured to implement a method according to claim 1.
